(19) United States
(12) Patent Application Publication
(10) Pub. No.: US 2025/0164311 A1
(43) Pub. Date: May 22, 2025

(54) DEVICE HAVING REDUCED OPTICAL CROSSTALK

(71) Applicant: ams International AG, Jona (CH)

(72) Inventors: Stephan MALKMUS, Puchheim (DE); Sebastian MUSCHICK, Jona (CH); Michael HIRMER, Wiesent (DE); Dan JACOBS, Hitzendorf (AT)

(21) Appl. No.: 18/838,966

(22) PCT Filed: Feb. 9, 2023
(86) PCT No.: PCT/EP2023/053204

§ 371 Date: Aug. 15, 2024

(30) Foreign Application Priority Data
Feb. 15, 2022 (GB) 2201994.7

(51) Int. Cl. G01J 1/44

(52) U.S. Cl. CPC G01J 1/44; G01J 2001/444

(57) ABSTRACT

A device comprising a display and a sensor is disclosed. The display comprises a plurality structures in a regular arrangement. The sensor comprises a radiation-sensitive device and radiation-emitting device arranged on a first axis. The display is configured to scatter a portion of radiation emitted by the radiation-emitting device with an intensity profile defined by the regular arrangement, the intensity profile having a first region of peak intensity extending along at least a second axis different to the first axis. Also disclosed is a method of reducing crosstalk in such a device.

### FIELD OF DISCLOSURE

The present disclosure is in the field of devices comprising displays and sensors, such as smartphones and the like, and in particular relates to a device having reduced crosstalk caused by the display.

### BACKGROUND

Sensors, such as proximity sensors, are commonly used in electronic devices such as smartphones, smart-watches, tablet devices and laptop computers, and in automotive applications. Such devices typically have displays, e.g. LED screens, for presenting information to a user.

A recent trend in portable device design, and in particular in the design of smartphones, is to maximize a display area by reducing an area of a bezel. This may be achieved, at least in part, by positioning sensors such as radiation sensors behind the display.

Sensors, such as proximity sensors and time-of-flight sensors, may be configured to emit radiation towards a target, and sense radiation reflected from the target to determine a proximity of the target. Such sensors may be generally known in the art as ‘reflective sensors’. When a reflective sensor is mounted behind a display, the emitted radiation propagates through the display towards the target and is reflected by the target back through the display towards the sensor.

It is known in the art to mount such sensors behind a cover glass (or cover plastic) to protect the sensor. The cover glass may reflect and/or scatter a portion of the emitted radiation. Such back scattering and/or reflections is known in the art as ‘crosstalk’ or ‘optical crosstalk’. Crosstalk may substantially limit capabilities of a sensor. For example, crosstalk may contribute to a baseline level of noise in a system, thereby reducing a dynamic range and signal-to-noise ratio of the sensor.

However, by mounting a sensor behind a display instead of simply a cover glass, problems associated with crosstalk may be exacerbated. For example, in some instances the display itself, e.g. structures within the display and layers forming the display, may reflect and/or scatter radiation that may be subsequently incident upon the sensor, thereby further contributing to a level of crosstalk.

It is therefore desirable to reduce crosstalk in applications wherein sensors such as proximity sensors are mounted behind a display.

Known techniques for reducing crosstalk include implementations of polarizers to distinguish between crosstalk and radiation reflected from a target. Other techniques include implementation of barrier, e.g. optical baffles, to limit incidence of back-scattered radiation upon the sensor. Other known techniques include implementations of optical filters and coatings to reduce back-scattering. Such solutions are costly to implement, require additional manufacturing steps and components, may be complex, and may provide limited reductions in crosstalk.

It is therefore desirable to provide an effective, low-complexity and low costs means to reduce crosstalk in a system comprising a sensors, such as a proximity sensors, mounted behind a display.

It is therefore an aim of at least one embodiment of at least one aspect of the present disclosure to obviate or at least mitigate at least one of the above identified shortcomings of the prior art.

### SUMMARY

The present disclosure is in the field of devices comprising displays and sensors, such as smartphones and the like, and in particular relates to a device having reduced crosstalk caused by the display, e.g. reduced crosstalk between an emitter and a receiver of the sensor.

According to a first aspect of the disclosure, there is provided a device comprising: a display comprising a plurality structures in a regular arrangement; and a radiation-sensitive device and a radiation-emitting device arranged on a first axis. The display is configured to scatter a portion of radiation emitted by the radiation-emitting device with an intensity profile defined by the regular arrangement, the intensity profile having a first region of peak intensity extending along at least a second axis different to the first axis.

The plurality of structures may comprise a plurality of radiation-emitting structures, e.g. light-emitting diodes (LEDs).

The plurality of structures may comprise Thin Film Transistors (TFT), or associated circuitry. For example, a plurality of TFTs may be provided on a backside of an Organic Light Emitting Diode (OLED) display or a standard TFT display, for controlling pixels of the display. In some examples, such TFTs may be a dominant source of scattering from the display.

The radiation-emitting device may comprise a plurality of radiation-emitting devices. In some examples, the first axis extends through a centre of the plurality of radiation-emitting devices.

The radiation-emitting device may, for example, comprise a plurality of Vertical Cavity Surface Emitting Lasers (VCSELs).

The radiation-sensitive device may comprise a plurality of radiation-sensitive devices. In some examples, the first axis extends through a centre of the plurality of radiation-sensitive devices.

The radiation-sensitive device may, for example, comprise one or more photodiodes. The radiation-sensitive device may, for example, comprise one or more Single-Photon Avalanche Diodes (SPADs).

The display may be configured to reflect a portion of radiation emitted by the radiation-emitting device with an intensity profile defined by the regular arrangement, the intensity profile corresponding to the first region of peak intensity extending along at least the second axis.

Advantageously, by having the second axis different to the first axis, the radiation-sensitive device may be located outside the first region of peak intensity, thereby reducing a level of crosstalk between the radiation-sensitive device and the radiation-emitting device.

The first axis may be rotated relative to the second axis such that the radiation-sensitive device is substantially outside the region of peak intensity.

Advantageously, a rotation of the first axis relative to the second axis may achieve a misalignment of the radiation-sensitive device and the first region of peak intensity, thereby reducing a level of crosstalk between the radiation-sensitive device and the radiation-emitting device. Beneficially, such a solution may merely require a change to a layout of a sensor in a device, and therefore represents a low-complexity solution to the problem of crosstalk. Effectively rotating the first axis, e.g. rotating the sensor relative to the display and/or moving the radiation-sensitive device relative to the radiation-emitting device, is a low-cost, or even no-cost solution to the problem of excessive crosstalk between the radiation-sensitive device and the radiation-emitting device caused by the display.

The first axis may be rotated relative to the second axis such that the radiation-sensitive device is within a region of minimum intensity.

Advantageously, an amount of crosstalk may be minimised by accurately positioning the first axis, e.g. rotating the first axis, relative to the second axis.

The first axis may be rotated relative to the second axis by an angle of +/−45 degrees, e.g. substantially +/−45 degrees.

In some examples, the first axis may be rotated relative to the second axis by an angle of approximately +/−45 degrees, e.g. between +/−50 degrees and +/−40 degrees. In further examples, the first axis may be rotated relative to the second axis by an angle of between +/−55 degrees and +/−35 degrees. The first axis may be rotated relative to the second axis such that the amount of crosstalk is at or below a threshold level, e.g. an acceptable level of crosstalk.

The intensity profile, e.g. the scattering intensity profile of the display, may have a second region of peak intensity. The second region of peak intensity may extend along a third axis. The third axis may be substantially orthogonal to the second axis.

For example, a display comprising structures, e.g. radiation-emitting structures, in a regular arrangement, e.g. a grid or array, over an area of a planar substrate may in combination with a reflective sensor produce back-scattered radiation having a profile with first and second regions of peak intensity, effectively forming a substantially cruciform region of peak intensity.

The radiation-sensitive device and the radiation-emitting device may be disposed behind the display. The radiation-sensitive device and the radiation-emitting device may be configured as a sensor for sensing one or more characteristics of a target disposed in front of the display The characteristic may correspond to a distance to the target.

The characteristic may correspond to a proximity of the target.

The characteristic may correspond to a reflectivity of the target.

The sensor may be configured for use in health monitoring applications.

The sensor may be configured to determine a distance to the target.

The sensor may be configured to determine an amplitude, e.g. an intensity, of reflected radiation emitted by the radiation-sensitive device and sensed by the radiation-emitting device. The amplitude may be used to determine a distance to the target. The amplitude may be used to determine characteristics of the target, e.g. in health monitoring applications.

The sensor may be configured to determine a phase of reflected radiation emitted by the radiation-sensitive device and sensed by the radiation-emitting device. The phase may be used to determine a distance to the target.

The regular arrangement of structures, e.g. radiation-emitting structures, may be configured to anisotropically reflect and/or scatter the portion of radiation emitted by the radiation-emitting device to provide the reflected/scattered portion of radiation with the intensity profile.

Advantageously, the anisotropic reflection and/or scattering provides predictable regions of low intensity, which may represent suitable locations for placement of the radiation-sensitive device to minimise or at least reduce the effects of crosstalk between the emitter and a receiver of the sensor, as caused by the display.

The regular arrangement may correspond to a grid, array, lattice and/or periodic pattern of the structures.

Advantageously, such a regular arrangement may result in reflections and back-scattering having distinct regions of high and low intensity, thereby enabling selection of a location of the radiation-sensitive device to minimise or at least reduce the effects of crosstalk between the radiation-emitting device and the radiation-sensitive device, due to the display.

The first region of peak intensity and/or the second region of peak intensity may comprise a plurality of maxima and minima due to diffraction of the portion of radiation by the display.

For example, the regular arrangement of structures may function effectively as a reflective and/or transmissive grating, resulting in back-scattering and/or reflections having a distinct interference pattern of maxima and minima.

The sensor may be configured as one of: a proximity sensor; a direct Time-of-Flight sensor; an indirect Time-of-Flight sensor; a gas sensor; a spectral sensor; or a sensor for health monitoring applications.

The sensor may be configured for use in a smoke detector. The sensor may be configured for particle sensing. The sensor may be configured as a rain sensors, for example in an automotive application. The sensor may be configured for a heart rate monitoring.

The sensor may, for example, be used for spectral sensing to determine a water content of an object.

The plurality of structures may comprise Organic Light Emitting Diodes (OLEDs) and/or micro-Light Emitting Diodes (μLEDs).

Implementation of the sensor behind a display, wherein the display comprises organic LEDs, may be known in the art as a “Behind-OLED” or “BOLED” application.

The device may be a communication device. The device may be a wearable device. The device may be a gaming device. The device may be an automotive device.

For example, the device may be a smartphone, a smartwatch, a tablet device, or the like.

The device may be implemented in a vehicle, such is in an instrument cluster or dashboard display.

The radiation-sensitive device and the radiation-emitting device may be provided as discrete devices arranged on the first axis. That is, the radiation-sensitive device and radiation-emitting device may be physically separate devices.

The radiation-sensitive device and the radiation-emitting device may be provided as a packaged device. That is, the radiation-sensitive device and the radiation-emitting device may be provided in a common package, encapsulant, or the like.

According to a second aspect of the disclosure, there is provided a method of reducing crosstalk between a radiation-sensitive device and radiation-emitting device arranged on a first axis, wherein a display comprising a plurality structures in a regular arrangement, the display configured to reflect and/or scatter a portion of radiation emitted by the radiation-emitting device with an intensity profile defined by the regular arrangement, the intensity profile having a first region of peak intensity extending along at least a second axis. The method comprises positioning the radiation-sensitive device relative to the display such that the second axis is different to the first axis.

The plurality of structures may comprise a plurality of radiation-emitting structures, e.g. LEDs.

Advantageously, by having the second axis different to the first axis, the radiation-sensitive device may be located outside the first region of peak intensity, thereby reducing a level of crosstalk between the radiation-sensitive device and the radiation-emitting device.

The method may comprise providing the first axis rotated relative to the second axis such that the crosstalk is minimized.

The method may comprise providing the first axis rotated relative to the second axis such that the crosstalk is below a maximum level and above a minimum threshold level.

Advantageously, a design trade-off may be made to select an optimum amount of crosstalk to be maintained for purposes of device calibration, while also maintaining a sufficient signal to noise ratio and/or dynamic range of a sensor provided by the radiation-sensitive device and the radiation-emitting device.

The radiation-sensitive device and the radiation-emitting device may be configured as a sensor. The method may comprise a step of calibration of the sensor, wherein the minimum threshold level defines an amount of crosstalk required for calibration of the sensor.

For example, when the sensor is a direct Time-of-Flight sensor, or an indirect Time-of-Flight sensor, a level of crosstalk the radiation-sensitive device and the radiation-emitting device of the sensor may be used in calibration to determine a ‘zero distance’, e.g. a minimum distance a target can be from the sensor.

The above summary is intended to be merely exemplary and non-limiting. The disclosure includes one or more corresponding aspects, embodiments or features in isolation or in various combinations whether or not specifically stated (including claimed) in that combination or in isolation. It should be understood that features defined above in accordance with any aspect of the present disclosure or below relating to any specific embodiment of the disclosure may be utilized, either alone or in combination with any other defined feature, in any other aspect or embodiment or to form a further aspect or embodiment of the disclosure.

### BRIEF DESCRIPTION OF THE PREFERRED EMBODIMENTS

These and other aspects of the present disclosure will now be described, by way of example only, with reference to the accompanying drawings, wherein:

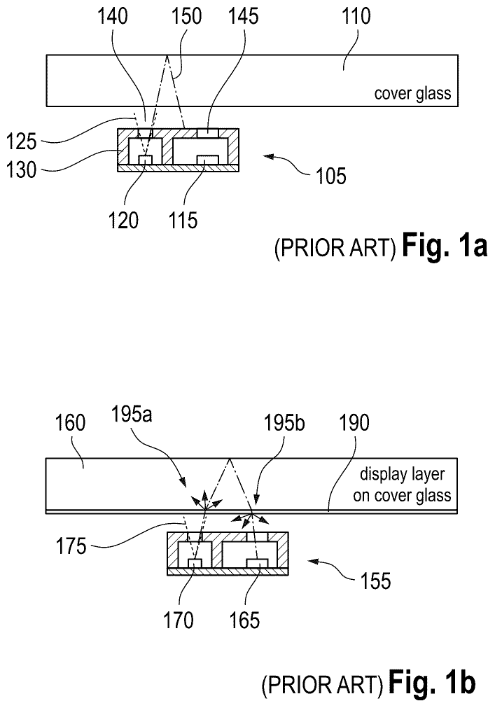

FIG. 1a depicts a prior art configuration of a sensor and a cover glass;

FIG. 1b depicts a prior art configuration of a sensor and a display;

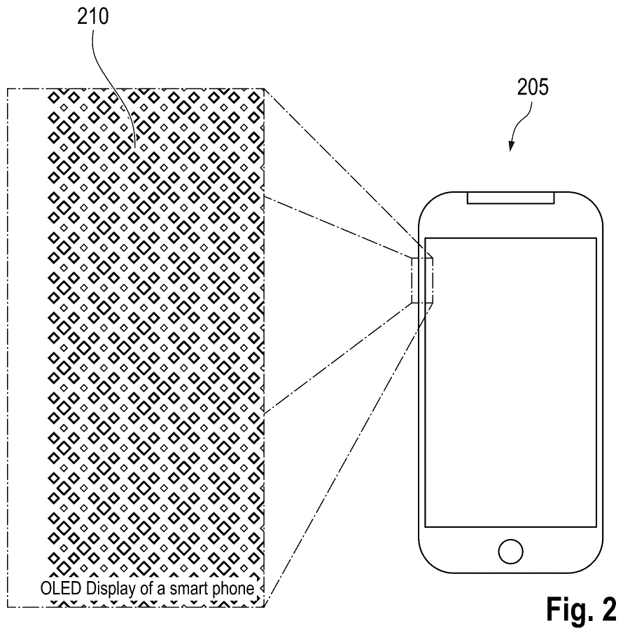

FIG. 2 depicts a plan view of a device comprising a display, and a magnified portion of the display;

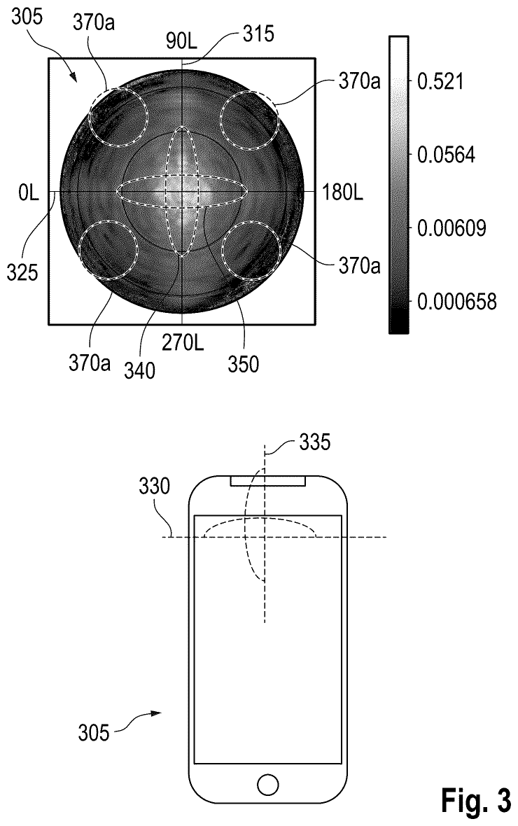

FIG. 3 depicts a logarithmic polar plot of a measured Bi-directional Transmission Distribution Function of an OLED display used in a smart phone, and a representation of the smartphone;

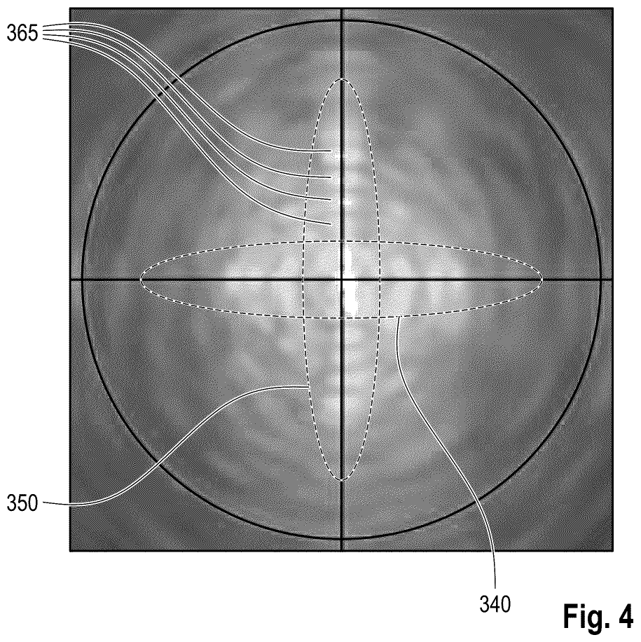

FIG. 4 depicts a magnified portion of the logarithmic polar plot of FIG. 3;

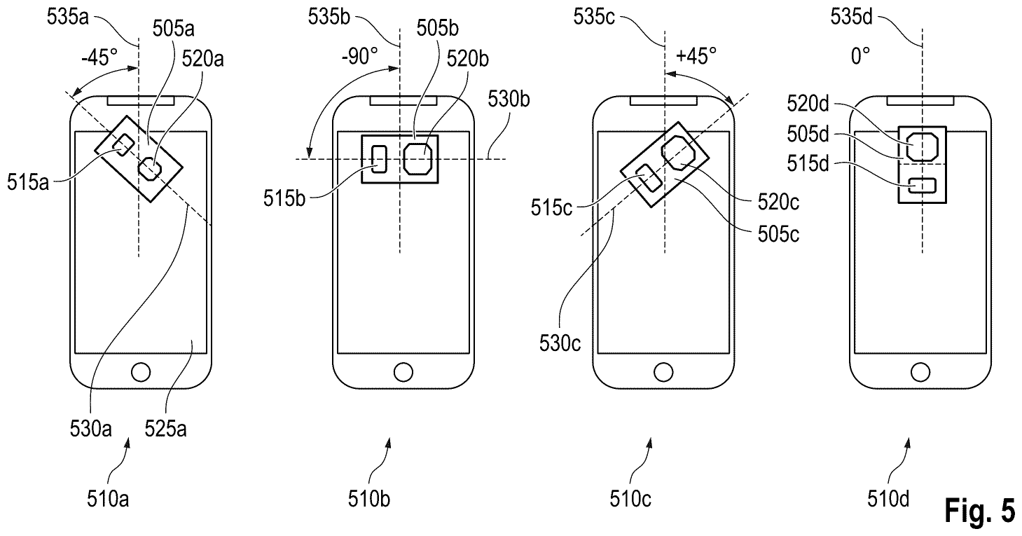

FIG. 5 depicts a range of different orientations of a sensor on a device relative to a display of the device;

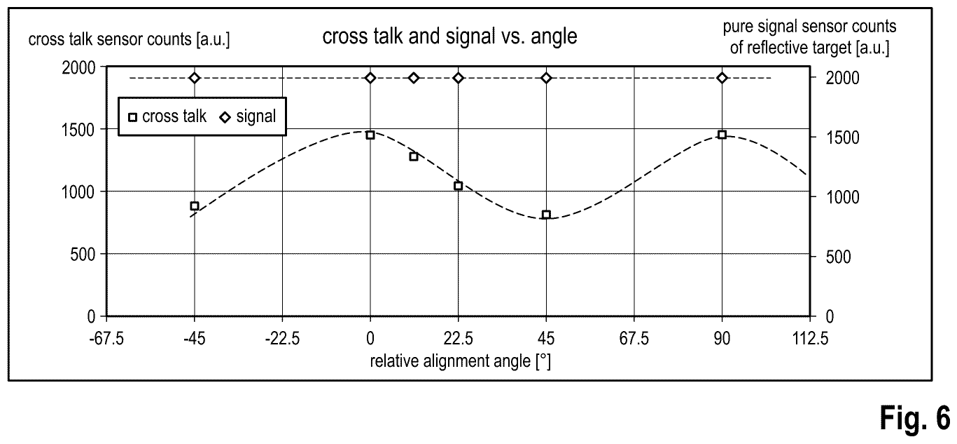

FIG. 6 is a graph depicting a level of crosstalk detected for various orientations of a sensor relative to a display;

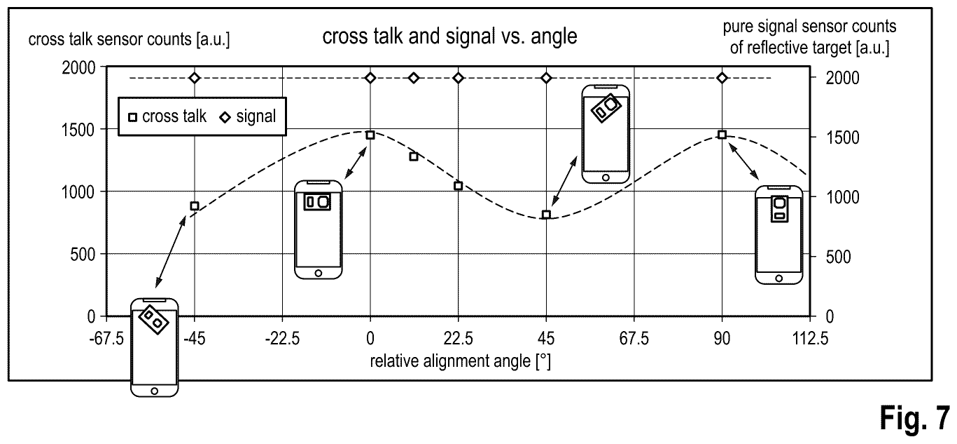

FIG. 7 corresponds to the graph of FIG. 6, also depicting devices having various orientations of a sensor corresponding to data points on the graph; and

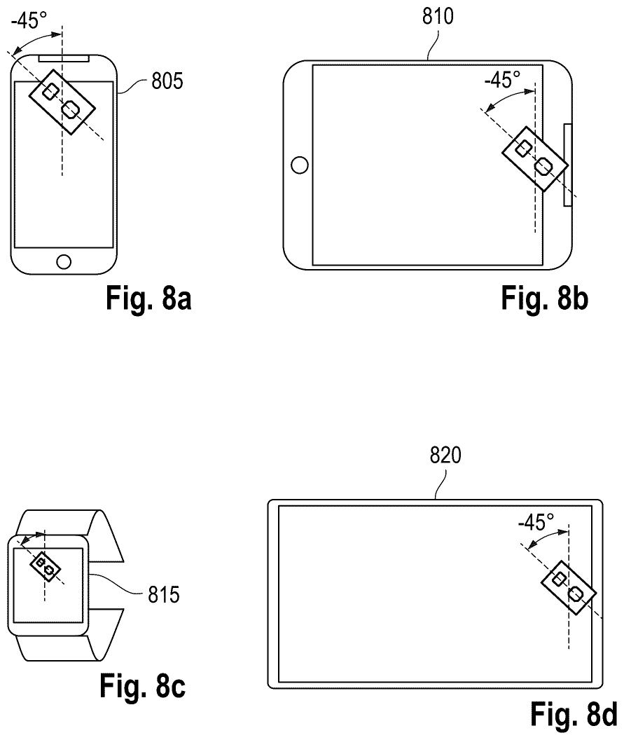

FIGS. 8a-d depicts examples of devices according to embodiments of the disclosure.

### DETAILED DESCRIPTION OF THE DRAWINGS

FIG. 1a depicts a prior art configuration of a sensor 105 and a cover glass 110.

The sensor 105 comprises radiation-sensitive device 115 and radiation-emitting device 120. The sensor 105 may, for example, be a proximity sensor or a time-of-flight sensor. As one example, the radiation-emitting device 120 may comprise a plurality of Vertical Cavity Surface Emitting Lasers (VCSELs) and the radiation-sensitive device 115 may comprise one or more photodiodes or Single-Photon Avalanche Diodes (SPADs).

The radiation-emitting device 120 is configured to emit radiation 125. In use, the radiation may propagate through the cover glass 110 towards a target (not shown) and be reflected by the target back through the cover glass 110 towards the radiation-sensitive device 115 of the sensor 105. A phase and/or amplitude of the received radiation, and/or a round-trip propagation time of the radiation may be used to determine a distance to the target.

In the example, the sensor 105 comprises an enclosure 130. The enclosure 130 had a first aperture 140 enabling radiation 125 emitted by the radiation-emitting device 120 to be directed towards the cover glass 110.

The enclosure 130 also has a second aperture 145 enabling reflected radiation to be incident upon the radiation-sensitive device 115.

In use, a portion 150 of emitted radiation 125 may be reflected by the cover glass 110 back towards the sensor 105. This may be due to non-ideal characteristics of the cover glass 110, e.g. impurities, scratches, surface debris and the like. In the depicted example, the enclosure 130 is configured to ensure that reflected radiation 125 is generally not incident upon the radiation-sensitive device 115.

There may be some further scattering of the radiation 125 within the cover glass 110 and at the surface of the cover glass 110, which is not shown in FIG. 1a.

FIG. 1b depicts a similar prior art configuration of a sensor 155 and a cover glass 160, except in this example the cover glass 160 has a display layer 190.

The sensor 155 comprises radiation-sensitive device 165 and radiation-emitting device 170, and corresponds to the sensor 105 of FIG. 1a.

The display layer 190 comprises a plurality radiation-emitting structures in a regular arrangement. The radiation-emitting structures are not shown in FIG. 1b, but are described in more detail below with reference to FIG. 2.

Due to the display layer 190, and in particular due to the plurality radiation-emitting structures forming the display layer 190, an increased amount of scattering and reflections of radiation 175 emitted by the radiation-emitting device 170 of the sensor 155 may occur. That is, the display layer 190 may comprise, for example, various layers of metal, organic structures, thin-film transistors, or the like.

Scattering and/or reflections may occur as radiation initially propagates through the display layer 190 towards a target, as depicted in FIG. 1b as first scattered radiation 195a. Scattering and/or reflections may also occur as radiation propagates through the display layer 190 after reflection from the target, as depicted in FIG. 1b as second scattered radiation 195b.

As such, the presence of a display layer 190 may increase an amount of scattering relative to a cover glass 110.

As shown in FIG. 1b, some of the scattered/reflected radiation may be incident upon the radiation-sensitive device 165 of the sensor 155, and thus may contribute to a measurable level of crosstalk between the sensor 155 and the display layer 190.

Such displays, e.g. one or more display layers formed on a substrate such as a cover glass, generally comprise a plurality of radiation-emitting structures provided in a regular arrangement. To illustrate this, FIG. 2 depicts a plan view of a device 205 comprising a display 210, and a magnified portion of the display.

For purposes of example only, the device 205 is a smartphone. The display 210 comprises a plurality of structures in a regular arrangement. In the example embodiment, the plurality of structures are radiation-emitting structures, e.g. pixels. As shown in the magnified portion of the display 210, the structures are periodically arranged in a regular grid.

It has been observed that radiation incident upon such a display 210 may be scattered and/or reflected with a distinct profile. That is, to at least some extent, the regular arrangement of structures forming the display may effectively act as a reflective and/or transmissive grating, producing reflected and/or scattered light characterised by a defined interference pattern.

To illustrate this, FIG. 3 depicts a logarithmic polar plot 305 of a measured Bi-directional Transmission Distribution Function of an OLED display used in a smart phone, and a representation of the smartphone 310.

The polar plot 305 is based on measurements of radiation indecent upon the OLED display with an angle of incidence of zero degrees. In this example, the radiation was infrared radiation, with a wavelength of approximately 1064 nanometers.

A vertical axis 315 in the plot corresponds to a vertical projected axis 335 of the OLED display. A horizontal axis 325 in the plot corresponds to a horizontal projected axis 330 of the OLED display.

The polar plot 305 clearly depicts pronounced scattering along the vertical axis 315 and along the horizontal axis 320.

That is, the display is configured to reflect and/or transmit a portion of radiation incident upon the display with an intensity profile defined by the regular arrangement of structures forming the display. In the example, the intensity profile has a first region 340 of peak intensity extending along the vertical axis 315 and a second region 350 of peak intensity extending along the horizontal axis 320.

FIG. 4 depicts a magnified portion of the logarithmic polar plot 305 of FIG. 3. It can be seen that the first region 340 of peak intensity comprise a plurality of maxima and minima due to diffraction of the portion of radiation by the display. Similarly, it can be seen that the second region 350 of peak intensity also comprise a plurality of maxima 365 and/or minima due to diffraction of the portion of radiation by the display.

As such, it can be determined from the polar plot 305 that there exist regions, e.g. regions 370a-d, of minimal or at least reduced intensity of scattered radiation. That is, in each quadrant defined by the intersection of the vertical axis 315 and the horizontal axis 320, there are regions 370a-d, of minimal or at least reduced intensity of scattered radiation. In the example shown, such regions 370a-d are substantially equidistant from the axis, e.g. at angles of 45, 135, 225 and 315 degrees, relative to the vertical axis 315 at an angle of 0 degrees.

It will be appreciated that specific location of the regions 370a-d of minimal or at least reduced intensity of scattered radiation relative to the vertical axis 315 and the horizontal axis 320 may vary depending upon, for example, the specific regular arrangement of structures in the display.

FIG. 5 depicts a range of different orientations of a sensor 505a-d on a device 510a-d, relative to a display 525a-d of the device.

In a first example, the sensor 505a comprises a radiation-sensitive device 515a and radiation-emitting device 520a arranged on a first axis 530. Although the description herein refers to a sensor 505a, it will be appreciated that in embodiments of the disclosure, the radiation-sensitive device 515a and the radiation-emitting device 520a may be provided as discrete devices arranged on the first axis 530, as described above.

The display comprises a plurality structures in a regular arrangement, e.g. as depicted in FIG. 2. The display is configured to reflect and/or scatter a portion of radiation emitted by the radiation-emitting device 520a with an intensity profile defined by the regular arrangement. The intensity profile has a first region of peak intensity extending along a second axis 535a, e.g. a vertical axis as depicted in FIG. 4. In this example, the intensity profile also has a second region of peak intensity extending along a third axis, e.g. a horizontal axis as depicted in FIG. 4.

In the first example, which corresponds to an embodiment of the disclosure, the first axis 530a is rotated relative to the second axis 535a by an angle of −45 degrees. As such, and as described in more detail below with reference to FIGS. 6 and 7, the radiation-sensitive device 515a is generally located in a region of minimal or at least reduced intensity of scattered radiation, e.g. regions 370a-d as depicted in FIG. 3.

In a second example, the sensor 505b comprises a radiation-sensitive device 515b and radiation-emitting device 520b arranged on a first axis 530b. The display comprises a plurality structures in a regular arrangement. The display is configured to reflect and/or scatter a portion of radiation emitted by the radiation-emitting device 520b with an intensity profile defined by the regular arrangement. The intensity profile has a first region of peak intensity extending along a second axis 535b, e.g. a vertical axis as depicted in FIG. 4. In this example, the intensity profile also has a second region of peak intensity extending along a third axis, e.g. a horizontal axis as depicted in FIG. 4.

In the second example, the first axis 530b is rotated relative to the second axis 535b by an angle of +90 degrees. As such, and as described in more detail below with reference to FIGS. 6 and 7, the radiation-sensitive device 515b is generally located in a region of maximum scattered radiation, e.g. regions 340 as depicted in FIG. 3.

A third examples corresponds to an embodiment of the disclosure. The third example generally corresponds to the first example, except the first axis 530c is rotated relative to the second axis 535c by an angle of +45 degrees. As such, and as described in more detail below with reference to FIGS. 6 and 7, the radiation-sensitive device 515c is generally located in a region of minimal or at least reduced intensity of scattered radiation, e.g. regions 370a-d as depicted in FIG. 3.

In a fourth example, the first axis 530d is aligned with the second axis 535d. As such, and as described in more detail below with reference to FIGS. 6 and 7, the radiation-sensitive device 515d is generally located in a region of maximum scattered radiation, e.g. regions 350 as depicted in FIG. 3.

FIG. 6 is a graph depicting a level of crosstalk detected for various orientations of a sensor relative to a display, including the examples depicted in FIG. 5. Also shown in FIG. 6 is a signal received by the sensor, reflected from a target.

The “relative alignment angle” corresponds to the alignment angle between the first axis and the second axis, e.g. first axis 530a-d and second axis 535a-d of the examples of FIG. 5.

It can be seen that with an alignment angle of −45 degrees, e.g. the first example of FIG. 5, a level of crosstalk is substantially minimized, and corresponds to approximately 800 sensor counts. At the same angle, a signal received from the target corresponds to approximately 1900 sensor counts. It will be appreciated that the example of FIG. 6 is provided for illustration only, and in a practical application the precise count may depend upon variables such as distance, target reflectivity, integration time, and/or sensor gain.

It can be seen that with an alignment angle of +45 degrees, e.g. the third example of FIG. 5, a level of crosstalk is again substantially minimized, and corresponds to approximately 800 cross talk sensor counts. At the same angle, a signal received from the target corresponds to approximately 1900 sensor counts.

It can be seen that with an alignment angle of +90 degrees, e.g. the second example of FIG. 5, a level of crosstalk is substantially maximized, and corresponds to approximately 1450 sensor counts. At the same angle, a signal received from the target corresponds to approximately 1900 sensor counts.

It can be seen that with an alignment angle of 0 degrees, e.g. the fourth example of FIG. 5, a level of crosstalk is substantially maximized, and corresponds to approximately 1450 sensor counts. At the same angle, a signal received from the target corresponds to approximately 1900 sensor counts.

That is, irrespective of the orientation of the sensors relative to the display, a reflected signal received from a target is relatively constant. In contrast, a signal corresponding to the level of crosstalk is clearly dependent upon the orientation of the sensor relative to the display. Thus, in devices according to embodiments of the disclosure, by careful selection of the orientation of the sensors relative to the display, crosstalk between the sensor and the display may be substantially reduced or minimized.

For purposes of illustrating the relationship between the orientation of the sensors and the display and the level of crosstalk, FIG. 7 is provided, which corresponds to the graph of FIG. 6 and also depicts devices of FIG. 5 having various orientations of a sensor corresponding to data points on the graph.

FIG. 8a depicts some embodiments of the disclosure. FIG. 8a depicts a smartphone 805, FIG. 8b depicts a tablet computing device 810, FIG. 8c depicts a wearable device 815, e.g. a smartwatch, and FIG. 8d depicts an automotive device 820, e.g. a dashboard display.

In each example embodiment 805, 810, 815, 820, the respective display comprises a plurality structures in a regular arrangement. In each example embodiment 805, 810, 815, 820 a respective sensor comprises a radiation-sensitive device and radiation-emitting device arranged on a first axis. In each example embodiment 805, 810, 815, 820, the respective display is configured to reflect and/or scatter a portion of radiation emitted by the respective radiation-emitting device with an intensity profile defined by the regular arrangement, the intensity profile having a first region of peak intensity extending along at least a respective second axis different to the respective first axis.

Although the disclosure has been described in terms of particular embodiments as set forth above, it should be understood that these embodiments are illustrative only and that the claims are not limited to those embodiments. Those skilled in the art will be able to make modifications and alternatives in view of the disclosure, which are contemplated as falling within the scope of the appended claims. Each feature disclosed or illustrated in the present specification may be incorporated in any embodiments, whether alone or in any appropriate combination with any other feature disclosed or illustrated herein.

REFERENCE NUMERALS

| | |
|---|---|
| 105 | sensor |
| 110 | cover glass |
| 115 | radiation-sensitive device |
| 120 | radiation-emitting device |
| 125 | radiation |
| 130 | enclosure |
| 140 | first aperture |
| 145 | second aperture |
| 150 | portion |
| 155 | sensor |
| 160 | cover glass |
| 165 | radiation-sensitive device |
| 170 | radiation-emitting device |
| 175 | radiation |
| 190 | display layer |
| 195a | first scattered radiation |
| 195b | second scattered radiation |
| 205 | device |
| 210 | display |
| 305 | polar plot |
| 310 | smartphone |
| 315 | vertical axis |
| 320 | horizontal axis |
| 330 | horizontal projected axis |
| 335 | vertical projected axis |
| 340 | first region |
| 350 | second region |
| 360 | minima |
| 365 | maxima |
| 370a-d | regions |
| 505a-d | sensors |
| 510a-d | device |
| 515a-d | radiation-sensitive device |
| 520a-d | radiation-emitting device |
| 525a-d | display |
| 530a-d | first axis |
| 535a-d | second axis |
| 805 | smartphone |
| 810 | tablet computing device |
| 815 | wearable device |
| 820 | automotive device |

1. A device comprising:
a display comprising a plurality structures in a regular arrangement; and
a radiation-sensitive device and a radiation-emitting device arranged on a first axis;
wherein the display is configured to scatter a portion of radiation emitted by the radiation-emitting device with an intensity profile defined by the regular arrangement, the intensity profile having a first region of peak intensity extending along at least a second axis different to the first axis.

2. The device of claim 1, wherein the first axis is rotated relative to the second axis such that the radiation-sensitive device is substantially outside the region of peak intensity.

3. The device of claim 1, wherein the first axis is rotated relative to the second axis such that the radiation-sensitive device is within a region of minimum intensity.

4. The device of claim 1, wherein the first axis is rotated relative to the second axis by an angle of substantially +/−45 degrees.

5. The device of claim 1 wherein the intensity profile has a second region of peak intensity extending along a third axis substantially orthogonal to the second axis.

6. The device of claim 1 wherein the radiation-sensitive device and the radiation-emitting device are disposed behind the display and configured as a sensor for sensing one or more characteristics of a target disposed in front of the display.

7. The device of claim 6, wherein the sensor is configured as one of:
a proximity sensor;
a direct Time-of-Flight sensor;
an indirect Time-of-Flight sensor;
a gas sensor;
a spectral sensor;
a sensor for health monitoring applications.

8. The device of claim 1, wherein:
the regular arrangement of structures is configured to anisotropically reflect and/or scatter the portion of radiation emitted by the radiation-emitting device to provide the reflected/scattered portion of radiation with the intensity profile; and/or
the regular arrangement corresponds to a grid, array, lattice and/or periodic pattern of the plurality of structures.

9. The device according to claim 1, wherein the first region of peak intensity, and when dependent on claim 5 also the second region of peak intensity, comprises a plurality of maxima and minima due to diffraction of the portion of radiation by the display.

10. The device of claim 1, wherein the plurality of structures comprise Organic Light Emitting Diodes (OLEDs) and/or micro-Light Emitting Diodes (μLEDs).

11. The device of claim 1, wherein the radiation-sensitive device and the radiation-emitting device are provided as a packaged device.

12. A method of reducing crosstalk between a radiation-sensitive device and a radiation-emitting device arranged on a first axis,
wherein a display comprises a plurality of structures in a regular arrangement, the display configured to scatter a portion of radiation emitted by the radiation-emitting device with an intensity profile defined by the regular arrangement, the intensity profile having a first region of peak intensity extending along at least a second axis,
the method comprising:
positioning the radiation-sensitive device relative to the display such that the second axis is different to the first axis.

13. The method of claim 12, comprising providing the first axis rotated relative to the second axis such that the crosstalk is minimised.

14. The method of claim 12, comprising providing the first axis rotated relative to the second axis such that the crosstalk is below a maximum level and above a minimum threshold level.

15. The method of claim 14, wherein the radiation-sensitive device and the radiation-emitting device are configured as a sensor, the method comprising a step of calibration of the sensor, wherein the minimum threshold level defines an amount of crosstalk required for calibration of the sensor.
